(19) United States
(12) Patent Application Publication
(10) Pub. No.: US 2024/0157877 A1
(43) Pub. Date: May 16, 2024

(54) REARVIEW MIRROR WITH AUTOMATIC RESETTING FUNCTION

(71) Applicant: Wenzhou Ronghui Automobile Technology Co., Ltd, Wenzhou City (CN)

(72) Inventor: ZHIFEI MU, Wenzhou City (CN)

(21) Appl. No.: 18/329,587

(22) Filed: Jun. 6, 2023

(30) Foreign Application Priority Data
Nov. 16, 2022 (CN) 202223041483.9

(51) Int. Cl. B60R 1/078; B60R 1/076

(52) U.S. Cl. CPC B60R 1/078; B60R 1/076

(57) ABSTRACT

A rearview mirror with an automatic resetting function. The rearview mirror includes a mirror housing and a mirror surface, a connecting groove, a resetting mechanism is connected in the connecting groove, and the resetting mechanism is configured to recover an original included angle formed by the mirror housing relative to a vehicle body. The resetting mechanism is transversely connected to a rotating mechanism, and the mirror housing and the resetting mechanism can rotate in an axial direction of the rotating mechanism to form visual angles of different angles. The rotating mechanism includes a mounting portion, and the mounting portion is configured to be mounted on column A of the vehicle body. The rearview mirror can be automatically reset after collision, the angle of the rearview mirror can be adjusted, and the rearview mirror is simple in structure, high in practicability and wide in applicability.

### TECHNICAL FIELD

The present disclosure relates to a rearview mirror with an automatic resetting function.

### BACKGROUND ART

A rearview mirror is a tool for a driver sitting on a seat of a cab to directly acquire external information such as rear, side, and bottom of a vehicle. In order to facilitate operation by the driver, prevent occurrence of driving safety accidents and ensure personal safety, all countries define that the rearview mirror must be mounted on the vehicle, and all the rearview mirrors must have a direction adjustment function. In a running process of the vehicle, collision and scraping are inevitably generated, and a traditional rearview mirror does not have an anti-collision function and is likely to be damaged in a collision or scraping process.

For the patent application document with the Application No. CN202120777183.3 and titled Locomotive Rearview Mirror, the patent includes a mirror body provided with a mirror and a base, where the mirror body and the base are connected by means of a transversely arranged rotating portion in a matching manner, such that the mirror body can rotate in an axial direction of the rotating portion; and a soft elastic object is arranged in a rotating portion in a matching manner. The rotating portion achieves limiting rotation between the mirror body and the base by means of a rotating shaft member. The soft elastic object is arranged at the rotating shaft member in a matching manner. A groove is provided in the base, the soft elastic object is arranged in the groove in a matching manner, the rotating shaft member connected between the mirror body and the base penetrates the soft elastic object, the rearview mirror can be easily adjusted to a specified angle, but an automatic resetting function is lacked, and the rearview mirror is complex in structure, such that the rearview mirror with an automatic resetting function is researched and developed at present.

### SUMMARY

An objective of the present disclosure is to provide a rearview mirror with an automatic resetting function. The rearview mirror may be automatically reset after collision, the angle of the rearview mirror may be adjusted, and the rearview mirror is simple in structure, high in practicability and wide in applicability.

In order to achieve the above objective, the present disclosure provides the following technical solution: a rearview mirror with an automatic resetting function includes a mirror housing and a mirror surface arranged in the mirror housing, where a connecting groove is provided in a side edge of the mirror housing, a first through hole is provided in a middle of the connecting groove, and a bottom of the connecting groove is in a symmetrical and uneven shape. A resetting mechanism is connected in the connecting groove, and the resetting mechanism is configured to recover an original included angle formed by the mirror housing relative to a vehicle body. The resetting mechanism includes a resetting housing, the resetting housing extends towards the connecting groove to be provided with a hollow rod, the hollow rod is arranged in the first through hole, and a protruding block matching a bottom of the connecting groove is arranged at a top of the hollow rod. The protruding block is arranged in the connecting groove, the protruding block is connected to a flexible member, when the mirror housing collides with other things to rotate, the connecting groove and the protruding block are staggered, the protruding block drives the flexible member to be compressed, and after collision, the mirror housing is driven to be automatically reset by resetting force of the flexible member. The resetting housing is transversely connected to a rotating mechanism, such that the mirror housing and the resetting mechanism may rotate in an axial direction of the rotating mechanism to form visual angles of different angles. The rotating mechanism includes a mounting portion, and the mounting portion is configured to be mounted on column A of the vehicle body.

Furthermore, a bottom of the resetting housing extends upwards to be provided with a groove, the flexible member includes a second through hole provided in a middle of the protruding block, the second through hole is provided with a first screw rod, one end of the first screw rod penetrates the hollow rod and is arranged in the groove to be provided with a first spring in a sleeving manner, and a position of the first spring is limited by means of a gasket and a nut.

Furthermore, the second through hole is movably connected to the hollow rod by means of a compensation block, when the mirror housing rotates, the connecting groove rotates to be staggered with the protruding block, the protruding block rotates to drive the compensation block to move upwards, and the compensation block drives the screw rod to move upwards to drive the gasket and the nut to move upwards, such that the first spring is in a compressed state in the groove.

Furthermore, a plurality of sector notches are provided in a top of the hollow rod by taking a center of the hollow rod as an axis, a plurality of sector blocks are arranged at the positions, corresponding to the sector notches, in the second through hole, and the sector blocks gradually become small from a bottom to a top. Moreover, sliding grooves are symmetrically provided in a side wall of the second through hole, a side wall of the compensation block is provided with sliding blocks corresponding to the sliding grooves, the compensation block is provided with a plurality of polygonal blocks corresponding to the sector notches, and the polygonal blocks and the sector blocks are spliced to match the sector notches.

Furthermore, a spherical groove is provided on an end surface, away from the mirror housing, of the resetting housing, the spherical groove is provided with a third through hole to be in communication with the groove, and the rotating mechanism cooperates with the spherical groove, such that the mirror housing and the resetting housing rotate in the axial direction of the rotating mechanism.

Furthermore, the rotating mechanism includes an L-shaped rotating housing, a cavity is provided inside the rotating housing, the end, facing the spherical groove, of the rotating housing is of a spherical portion, and the spherical portion is provided with a fourth through hole. A tightening member is transversely arranged in the spherical portion, the tightening member transversely penetrates the third through hole to achieve connection between the resetting housing and the rotating housing, and pressure between the rotating housing and the spherical groove is adjusted to generate a damping effect.

Furthermore, the tightening member includes a second screw rod, one end of the second screw rod is provided with a spherical block corresponding to a length of the third through hole, and the other end of the second screw rod is provided with a second spring in a sleeving manner and is connected to the second spring by means of a T-shaped block, a gasket, and a nut. The second spring abuts between the spherical block and the T-shaped block, the second spring is compressed by rotating the position of the nut on the second screw rod, and compression force of the second spring makes resistance be generated between an outer end surface of the spherical block and an inner wall of the spherical portion, thereby generating resistance between an outer end surface of the spherical portion and an interior of the spherical groove.

Furthermore, the other end of the rotating housing is of an arc-shaped surface, the mounting portion is arranged at the arc-shaped surface, the mounting portion includes an elastic ring, and the elastic ring and the arc-shaped surface form a complete circular ring. One end of the elastic ring is fixedly connected to the rotating housing by means of a bolt, the other end of the elastic ring is connected to an adjusting member, and a position of the elastic ring is changed by rotating the adjusting member, thereby forming circular rings of different diameters.

Furthermore, the other end of the elastic ring extends to form a circular hole channel in an enclosed manner, the adjusting member includes a columnar body arranged in the circular hole channel, a threaded hole is provided in a middle of the columnar body, and a third screw rod is obliquely arranged in the threaded hole in a penetrating manner. One end of the third screw rod abuts against an inner wall of the rotating housing, the other end of the third screw rod penetrates out of the threaded hole and the rotating housing and is exposed outside, and the columnar body drives the elastic ring to reciprocate in a lengthwise direction of the third screw rod by rotating the third screw rod.

The present disclosure has the beneficial effects:
1. Since the protruding block and the connecting groove are both uneven and achieve mutual matching, when collision occurs to the mirror housing, the protruding block and the connecting groove are staggered, when the protruding block rotates, the compensation block is promoted to move upwards, the first screw rod is driven to move upwards, and compression of the first spring is achieved; and after collision, the first spring is reset, and the mirror housing is driven to return to an original angle.
2. The resetting mechanism is connected to the rotating mechanism by means of the tightening member, the tightening member includes the second screw rod, the second spring, and the spherical block that are transverse, and force is generated by means of the compression of the second spring, such that a hemispherical body is tightly attached to the spherical portion, the spherical portion is tightly attached to the spherical groove, resistance is generated, rotation of the mirror housing and the resetting mechanism is satisfied, and a damping effect may also be generated to prevent loosening.
3. By rotating a third bolt, the size change of a mounting ring formed by the elastic ring and the arc-shaped surface is achieved, such that columns A with different sizes on different vehicle types are mounted, and applicability and practicability of the rearview mirror are achieved.

### BRIEF DESCRIPTION OF THE DRAWINGS

FIG. 1 is a perspective schematic diagram of a rearview mirror with an automatic resetting function;

FIG. 2 is an exploded diagram of FIG. 1;

FIG. 3 is a decomposition diagram of a resetting mechanism and a rotating mechanism in FIG. 1;

FIG. 4 is a schematic diagram of a compensation block and a protruding block in a resetting mechanism;

reference numerals in figures: 1, mirror housing; 2, mirror surface; 3, connecting groove; 31, first through hole; 4, resetting mechanism; 41, resetting housing; 42, hollow rod; 421, sector notch; 43, protruding block; 431, second through hole; 432, sector block; 433, sliding groove; 44, groove, 45, first spring; 46, first screw rod; 47, compensation block; 471, polygonal block; 472, sliding block; 48, spherical groove; 5, rotating mechanism; 51, rotating housing; 52, spherical portion; 521, fourth through hole; 53, tightening member; 531, second screw rod; 532, spherical block; 533, second spring; 534, T-shaped block; 6, mounting portion; 61, elastic ring; 62, adjusting member; 621, columnar body; 622, third screw rod; and 7, cover.

### DETAILED DESCRIPTION OF THE EMBODIMENTS

In order to further illustrate the technical means configured to achieving the intended objectives of the present disclosure and the technical effects of the present disclosure, the particular embodiments, structures and features of the present disclosure, and effects thereof are described in detail hereinafter in conjunction with the accompanying drawings and preferred examples.

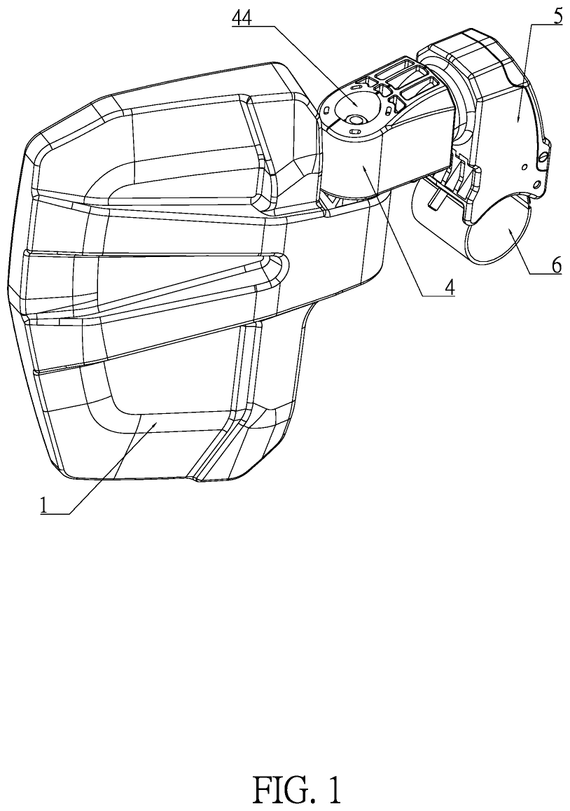

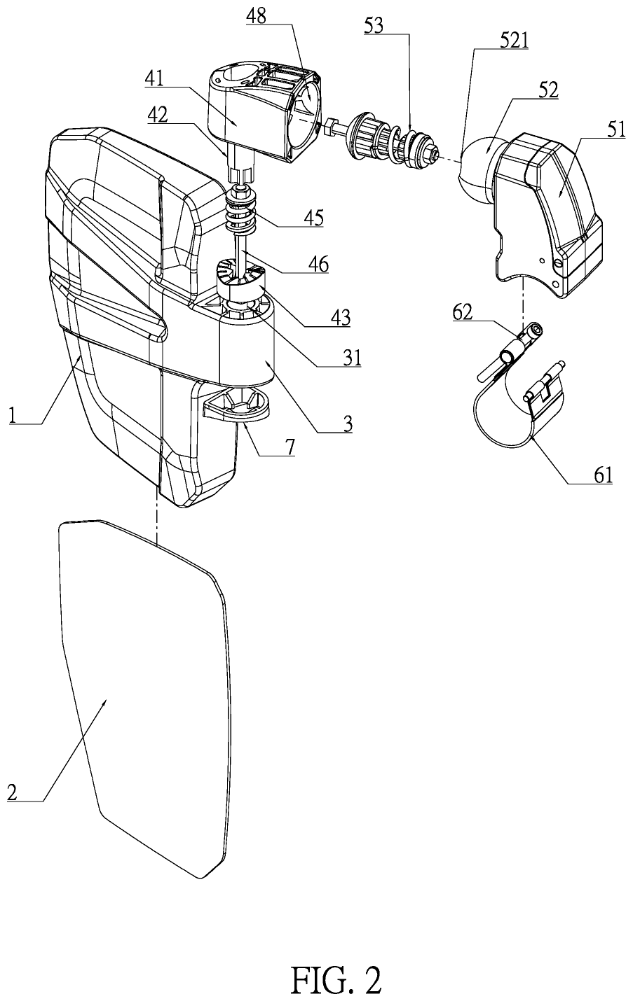

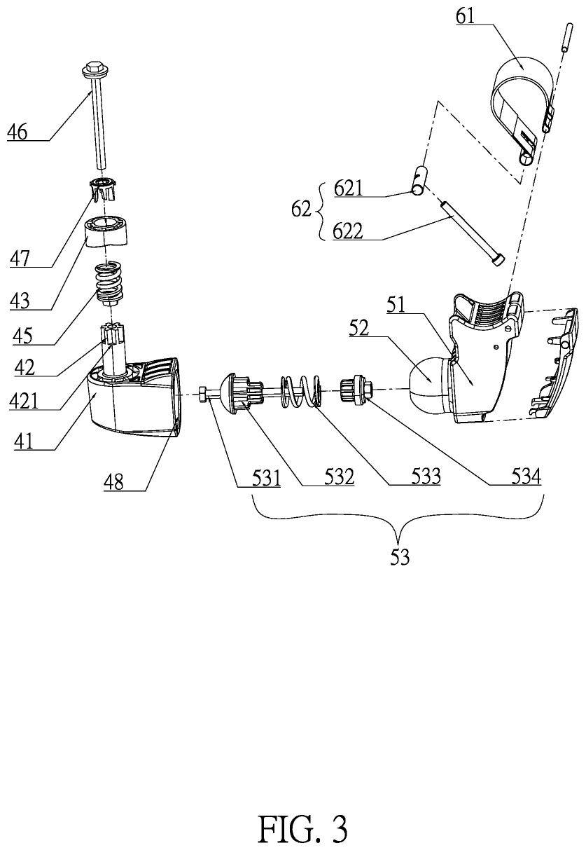

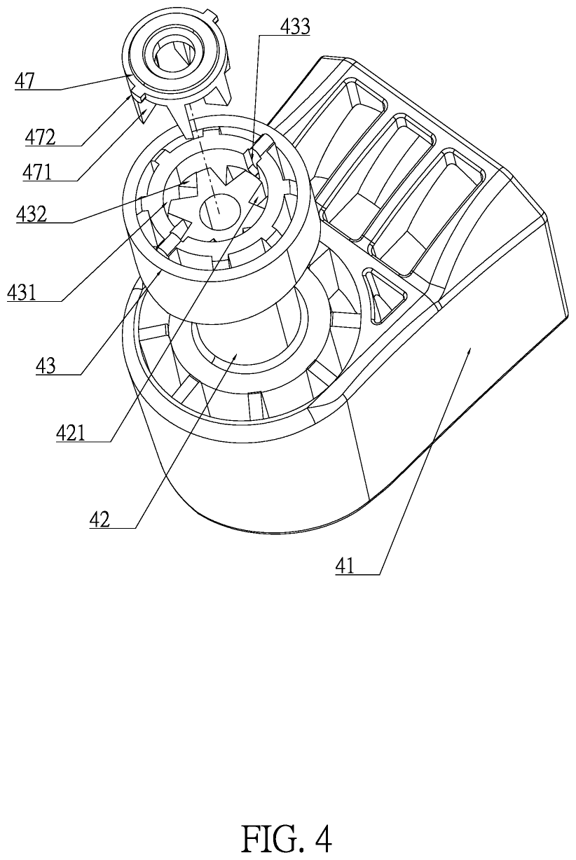

With reference to FIGS. 1-4, for a rearview mirror with an automatic resetting function of this example, a connecting groove 3 is provided in a side edge of a mirror housing 1, a first through hole 31 is provided in a middle of the connecting groove 3, and a bottom of the connecting groove 3 is in a symmetrical and uneven shape. A resetting mechanism 4 is connected in the connecting groove 3, and the resetting mechanism 4 is configured to recover an original included angle formed by the mirror housing 1 relative to a vehicle body. The resetting mechanism 4 includes a resetting housing 41, the resetting housing 41 extends towards the connecting groove 3 to be provided with a hollow rod 42, the hollow rod 42 is arranged in the first through hole 31, and a protruding block 43 matching a bottom of the connecting groove 3 is arranged at a top of the hollow rod 42. The protruding block 43 is arranged in the connecting groove 3, the protruding block 43 is connected to a flexible member, when the mirror housing 1 collides with other things to rotate, the connecting groove 3 and the protruding block 43 are staggered, the protruding block 43 drives the flexible member to be compressed, and after collision, the mirror housing 1 is driven to be automatically reset by resetting force of the flexible member. The resetting housing 41 is transversely connected to a rotating mechanism 5, such that the mirror housing 1 and the resetting mechanism 4 may rotate in an axial direction of the rotating mechanism 5 to form visual angles of different angles. The rotating mechanism 5 includes a mounting portion 6, and the mounting portion 6 is configured to be mounted on column A of the vehicle body.

On the basis of the above example, a bottom of the resetting housing 41 extends upwards to be provided with a groove 44. The flexible member includes a second through hole 431 provided in a middle of the protruding block 43, the second through hole 431 is provided with a first screw rod 46, one end of the first screw rod 46 penetrates the hollow rod 42 and is arranged in the groove 44 to be provided with a first spring 45 in a sleeving manner, and a position of the first spring 45 is limited by means of a gasket and a nut.

On the basis of the above example, the second through hole 431 is movably connected to the hollow rod 42 by means of a compensation block 47, when the mirror housing 1 rotates, the connecting groove 3 rotates to be staggered with the protruding block 43, the protruding block 43 rotates to drive the compensation block 47 to move upwards, and the compensation block 47 drives the first screw rod 46 to move upwards to drive the gasket and the nut to move upwards, such that the first spring 45 is in a compressed state in the groove 44.

On the basis of the above example, a plurality of sector notches 421 are provided in a top of the hollow rod 42 by taking a center of the hollow rod 42 as an axis, a plurality of sector blocks 432 are arranged at the positions, corresponding to the sector notches 421, in the second through hole 431, and the sector blocks 432 gradually become small from a bottom to a top. Moreover, sliding grooves 433 are symmetrically provided in a side wall of the second through hole 431, and a side wall of the compensation block 47 is provided with sliding blocks 472 corresponding to the sliding grooves 433. The compensation block 47 is provided with a plurality of polygonal blocks 471 corresponding to the sector notches 421, and the polygonal blocks 471 and the sector blocks 432 are spliced to match the sector notches 421.

On the basis of the above example, a spherical groove 48 is provided on an end surface, away from the mirror housing 1, of the resetting housing 41, the spherical groove 48 is provided with a third through hole to be in communication with the groove 44, and the rotating mechanism 5 cooperates with the spherical groove 48.

On the basis of the above example, the rotating mechanism 5 includes an L-shaped rotating housing 51, a cavity is provided inside the rotating housing 51, the end, facing the spherical groove 48, of the rotating housing 51 is of a spherical portion 52, and the spherical portion 52 is provided with a fourth through hole 521. A tightening member 53 is transversely arranged in the spherical portion 52, the tightening member 53 transversely penetrates the third through hole to achieve connection between the resetting housing 41 and the rotating housing 51, and pressure between the rotating housing 51 and the spherical groove 48 is adjusted to generate a damping effect.

On the basis of the above example, the tightening member 53 includes a second screw rod 531, one end of the second screw rod 531 is provided with a spherical block 532 corresponding to a length of the third through hole, and the other end of the second screw rod 531 is provided with a second spring 533 in a sleeving manner and is connected to the second spring by means of a T-shaped block 534, a gasket, and a nut. The second spring 533 abuts between the spherical block 532 and the T-shaped block 534, the second spring 533 is compressed by rotating the position of the nut on the second screw rod 531, and compression force of the second spring 533 makes resistance be generated between an outer end surface of the spherical block 532 and an inner wall of the spherical portion 52, thereby generating resistance between an outer end surface of the spherical portion 52 and an interior of the spherical groove 48.

On the basis of the above example, the other end of the rotating housing 51 is of an arc-shaped surface, and the mounting portion 6 is arranged at the arc-shaped surface. The mounting portion 6 includes an elastic ring 61, and the elastic ring 61 and the arc-shaped surface form a complete circular ring. One end of the elastic ring 61 is fixedly connected to the rotating housing 51 by means of a bolt, the other end of the elastic ring is connected to an adjusting member 62, and a position of the elastic ring 61 is changed by rotating the adjusting member 62, thereby forming circular rings of different diameters.

On the basis of the above example, the other end of the elastic ring 61 extends to form a circular hole channel in an enclosed manner, the adjusting member 62 includes a columnar body 621 arranged in the circular hole channel, a threaded hole is provided in a middle of the columnar body 621, and a third screw rod 622 is obliquely arranged in the threaded hole in a penetrating manner. One end of the third screw rod 622 abuts against an inner wall of the rotating housing 51, the other end of the third screw rod penetrates out of the threaded hole and the rotating housing 51 and is exposed outside, and the columnar body 621 drives the elastic ring 61 to reciprocate in a lengthwise direction of the third screw rod 622 by rotating the third screw rod 622.

The above improvement is specifically as follows: as shown in FIGS. 1-4, many types of rearview mirrors in the prior art do not have collision resistance and do not have a resetting function, a rearview mirror with an automatic resetting function is provided. The rearview mirror includes the mirror housing 1 and the mirror surface 2 arranged in the mirror housing 1, the connecting groove 3 is provided in the side edge of the mirror housing 1, and the first through hole 31 is provided in the middle of the connecting groove 3. The bottom of the connecting groove 3 is in the symmetrical and uneven shape, the uneven shape includes concave surfaces and convex surface, and any concave surface is adjacent to one convex surface. The resetting mechanism 4 is arranged in the connecting groove 3. The resetting mechanism 4 includes a resetting housing 41, the resetting housing 41 is provided with the hollow rod 42 towards the first through hole 31, the hollow rod 42 is arranged in the first through hole 31, and the protruding block 43 matching the connecting groove 3 is arranged at the top of the hollow rod 42. The protruding block 43 is movably connected to the top of the hollow rod 42 by means of the compensation block 47, the second through hole 431 is provided in the middle of the protruding block 43, and the bottom of the resetting housing 41 extends upwards to form the groove 44. The second through hole 431 is provided with the first screw rod 46, and one end of the first screw rod 46 penetrates the gasket, the compensation block 47, the protruding block 43, the hollow rod 42, and the groove 44 to be arranged in the groove 44 and is provided with the first spring 45 in the sleeving manner. One end of the first spring 45 abuts against the bottom of the groove 44, and the other end of the first spring achieve limiting of the first spring 45 by mounting the gasket and the nut on the first screw rod 46, and the compression force and the restoring force of the first spring 45 may be achieved by means of the position of the nut on the first screw rod 46.

The plurality of sector notches 421 are provided in the top of the hollow rod 42 by taking the center of the hollow rod 42 as an axis, the plurality of sector blocks 432 are arranged at the positions, corresponding to the sector notches 421, in the second through hole 431, and the sector blocks 432 gradually become small from the bottom to the top. The sliding grooves 433 are symmetrically provided in the side wall of the second through hole 431, and the side wall of the compensation block 47 is provided with the sliding blocks 472. A circular hole is provided in a middle of the compensation block 47, a bottom of the compensation block 47 is provided with a plurality of polygonal blocks 471 corresponding to the sector notches 421, and the polygonal blocks 471 and the sector blocks 432 are spliced to match the sector notches 421. By means of shape setting of the polygonal blocks 471, gaps between the sector blocks 432 of the protruding block 43 and the sector notches 421 at the top of the hollow rod 42 are compensated, and the sector blocks 432, the polygonal blocks 471 and the sector notches 421 tightly match each other so as to prevent jitter between the mirror surface, the mirror housing and the resetting housing. When collision occurs to the mirror housing 1 and the protruding block 43 is staggered and rotates, the compensation block 47 will not rotate synchronously, is limited by the sliding grooves 433 to move upwards and drives the first bolt to move up during moving upwards, such that the first spring 45 in the groove 44 is driven to be compressed. After the collision, the force free of rotation of the first spring 45 may produce the restoring force which drives the mirror housing 1 to return to the original position.

The spherical groove 48 is provided on the end surface, away from the mirror housing 1, of the resetting housing 41, and the spherical groove 48 is provided with the third through hole to be in communication with the groove 44. The rotating mechanism 5 includes the L-shaped rotating housing 51, the cavity is provided inside the rotating housing 51, the end, facing the spherical groove 48, of the rotating housing 51 is of the spherical portion 52, and the spherical portion 52 is provided with the fourth through hole 521. The tightening member 53 is transversely arranged in the spherical portion 52, the tightening member 53 includes the second screw rod 531, and one end of the second screw rod 531 transversely penetrates the spherical groove 48 to be fixed to the spherical groove. The second screw rod is provided with the spherical block 532, and the outer surface of the spherical block 532 matches the inner wall of the spherical portion 52 in an attached manner. The other end of the second screw rod 531 is provided with the second spring 533 in a sleeving manner and is connected to the second spring by means of the T-shaped block 534, the gasket, and the nut, and the second spring 533 abuts between the spherical block 532 and the T-shaped block 534. The second spring 533 is compressed to generate force towards the spherical block 532, such that the resistance is generated between the outer end surface of the spherical block 532 and the inner wall of the spherical portion 52, thereby generating the resistance between the outer end surface of the spherical portion 52 and the interior of the spherical groove 48 to achieve a damping effect and prevent loosening of the mirror housing 1, the resetting mechanism 4, and the spherical portion 52. An angle of the mirror housing 1 may be adjusted with greater force, and during loosening, the damping effect may be enhanced by rotating the nut.

The other end of the rotating housing 51 is of the arc-shaped surface, the mounting portion 6 is arranged at the arc-shaped surface, the mounting portion 6 includes the elastic ring 61, and the elastic ring 61 and the arc-shaped surface form the complete circular ring. One end of the elastic ring 61 is fixedly connected to the rotating housing 51 by means of the bolt, and the other end of the elastic ring is connected to an adjusting member 62. The adjusting member 62 includes the columnar body 621, and the columnar body 621 is arranged in the circular hole channel which is formed by means of extension of the other end of the elastic ring 61 in an enclosed manner. The threaded hole is provided in the middle of the columnar body 621, and the third screw rod 622 is obliquely arranged in the threaded hole in a penetrating manner. The third screw rod 622 and the columnar body 621 form a cross, one end of the third screw rod 622 abuts against the inner wall of the rotating housing 51, and the other end of the third screw rod penetrates out of the threaded hole and the rotating shell 51 to be exposed outside. By rotating the exposed third screw rod 622, the columnar body 621 drives the elastic ring 61 to move in the lengthwise direction of the third screw rod 622 to form the mounting portion 6 of different sizes to be adapted to columns A of different diameters, and columns A are stand columns on both sides of a front windshield.

The foregoing descriptions are merely preferred examples of the present disclosure, and are not intended to limit the present disclosure in any form. Although the present disclosure has been disclosed as above by means of the preferred examples, these examples are not for defining the present disclosure. Those skilled in the art can make certain alterations or modifications by using the technical contents disclosed above without departing from the scope of the technical solutions of the present disclosure so as to arrive at equivalent examples with equivalent changes. However, any simple amendments, equivalent changes, and modifications made to the above examples according to the technical essence of the present disclosure without departing from the contents of the technical solutions of the present disclosure still fall within the scope of the technical solutions of the present disclosure.

What is claimed is:

1. A rearview mirror with an automatic resetting function, comprising a mirror housing (1) and a mirror surface (2) arranged in the mirror housing (1), wherein a connecting groove (3) is provided in a side edge of the mirror housing (1), a first through hole (31) is provided in a middle of the connecting groove (3), a bottom of the connecting groove (3) is in a symmetrical and uneven shape, a resetting mechanism (4) is connected in the connecting groove (3), the resetting mechanism (4) is configured to recover an original included angle formed by the mirror housing (1) relative to a vehicle body, the resetting mechanism (4) comprises a resetting housing (41), the resetting housing (41) extends towards the connecting groove (3) to be provided with a hollow rod (42), the hollow rod (42) is arranged in the first through hole (31), a protruding block (43) matching a bottom of the connecting groove (3) is arranged at a top of the hollow rod (42), the protruding block (43) is arranged in the connecting groove (3), the protruding block (43) is connected to a flexible member, when the mirror housing (1) collides with other things to rotate, the connecting groove (3) and the protruding block (43) are staggered, the protruding block (43) drives the flexible member to be compressed, after collision, the mirror housing (1) is driven to be automatically reset by resetting force of the flexible member, the resetting housing (41) is transversely connected to a rotating mechanism (5), such that the mirror housing (1) and the resetting mechanism (4) rotate in an axial direction of the rotating mechanism (5) to form visual angles of different angles, the rotating mechanism (5) comprises a mounting portion (6), and the mounting portion (6) is configured to be mounted on column A of the vehicle body.

2. The rearview mirror with an automatic resetting function according to claim 1, wherein a bottom of the resetting housing (41) extends upwards to be provided with a groove (44), the flexible member comprises a second through hole (431) provided in a middle of the protruding block (43), the second through hole (431) is provided with a first screw rod (46), one end of the first screw rod (46) penetrates the hollow rod (42) and is arranged in the groove (44) to be provided with a first spring (45) in a sleeving manner, and a position of the first spring (45) is limited by means of a gasket and a nut.

3. The rearview mirror with an automatic resetting function according to claim 2, wherein the second through hole (431) is movably connected to the hollow rod (42) by means of a compensation block (47), when the mirror housing (1) rotates, the connecting groove (3) rotates to be staggered with the protruding block (43), the protruding block (43) rotates to drive the compensation block (47) to move upwards, and the compensation block (47) drives the first screw rod (46) to move upwards to drive the gasket and the nut to move upwards, such that the first spring (45) is in a compressed state in the groove (44).

4. The rearview mirror with an automatic resetting function according to claim 3, wherein a plurality of sector notches (421) are provided in a top of the hollow rod (42) by taking a center of the hollow rod (42) as an axis, a plurality of sector blocks (432) are arranged at the positions, corresponding to the sector notches (421), in the second through hole (431), the sector blocks (432) gradually become small from a bottom to a top, sliding grooves (433) are symmetrically provided in a side wall of the second through hole (431), a side wall of the compensation block (47) is provided with sliding blocks (472) corresponding to the sliding grooves (433), the compensation block (47) is provided with a plurality of polygonal blocks (471) corresponding to the sector notches (421), and the polygonal blocks (471) and the sector blocks (432) are spliced to match the sector notches (421).

5. The rearview mirror with an automatic resetting function according to claim 4, wherein a spherical groove (48) is provided on an end surface, away from the mirror housing (1), of the resetting housing (41), the spherical groove (48) is provided with a third through hole to be in communication with the groove (44), and the rotating mechanism (5) cooperates with the spherical groove (48).

6. The rearview mirror with an automatic resetting function according to claim 5, wherein the rotating mechanism (5) comprises an L-shaped rotating housing (51), a cavity is provided inside the rotating housing (51), the end, facing the spherical groove (48), of the rotating housing (51) is of a spherical portion (52), the spherical portion (52) is provided with a fourth through hole (521), a tightening member (53) is transversely arranged in the spherical portion (52), the tightening member (53) transversely penetrates the third through hole to achieve connection between the resetting housing (41) and the rotating housing (51), and pressure between the rotating housing (51) and the spherical groove (48) is adjusted to generate a damping effect.

7. The rearview mirror with an automatic resetting function according to claim 6, wherein the tightening member (53) comprises a second screw rod (531), one end of the second screw rod (531) is provided with a spherical block (532) corresponding to a length of the third through hole, the other end of the second screw rod (531) is provided with a second spring (533) in a sleeving manner and is connected to the second spring by means of a T-shaped block (534), a gasket, and a nut, the second spring (533) abuts between the spherical block (532) and the T-shaped block (534), the second spring (533) is compressed by rotating the position of the nut on the second screw rod (531), and compression force of the second spring (533) makes resistance be generated between an outer end surface of the spherical block (532) and an inner wall of the spherical portion (52), thereby generating resistance between an outer end surface of the spherical portion (52) and an interior of the spherical groove (48).

8. The rearview mirror with an automatic resetting function according to claim 7, wherein the other end of the rotating housing (51) is of an arc-shaped surface, the mounting portion (6) is arranged at the arc-shaped surface, the mounting portion (6) comprises an elastic ring (61), the elastic ring (61) and the arc-shaped surface form a complete circular ring, one end of the elastic ring (61) is fixedly connected to the rotating housing (51) by means of a bolt, the other end of the elastic ring is connected to an adjusting member (62), and a position of the elastic ring (61) is changed by rotating the adjusting member (62), thereby forming circular rings of different diameters.

9. The rearview mirror with an automatic resetting function according to claim 8, wherein the other end of the elastic ring (61) extends to form a circular hole channel in an enclosed manner, the adjusting member (62) includes a columnar body (621) arranged in the circular hole channel, a threaded hole is provided in a middle of the columnar body (621), and a third screw rod (622) is obliquely arranged in the threaded hole in a penetrating manner, One end of the third screw rod (622) abuts against an inner wall of the rotating housing (51), the other end of the third screw rod penetrates out of the threaded hole and the rotating housing (51) and is exposed outside, and the columnar body (621) drives the elastic ring (61) to reciprocate in a lengthwise direction of the third screw rod (622) by rotating the third screw rod (622).
